(19) United States
(12) Patent Application Publication
(10) Pub. No.: US 2025/0253550 A1
(43) Pub. Date: Aug. 7, 2025

(54) PRE-CRIMPED TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shunya TAKEUCHI, Mie (JP)

(21) Appl. No.: 18/856,881

(22) PCT Filed: Apr. 18, 2023
(86) PCT No.: PCT/JP2023/015493

§ 371 Date: Oct. 15, 2024

(30) Foreign Application Priority Data
Apr. 21, 2022 (JP) 2022-069893

(51) Int. Cl. H01R 4/18

(52) U.S. Cl. CPC H01R 4/184

(57) ABSTRACT

A pre-crimped terminal includes a terminal connecting portion, a wire connecting portion disposed behind the terminal connecting portion and to be connected to the wire, and a coupling portion coupling the terminal connecting portion and the wire connecting portion. The terminal connecting portion includes a first bottom wall and a pair of first side walls. The coupling portion includes a second bottom wall and a pair of second side walls. The wire connecting portion includes a third bottom wall and a pair of third side walls. The wire connecting portion is crimped to the wire. The second side wall is integrally formed to the third side wall in a range reaching a top of the third side wall most distant from the third bottom wall and coupled to the third side wall over an entire height of the second side wall.

### TECHNICAL FIELD

The present disclosure relates to a pre-crimped terminal before being crimped to a wire.

### BACKGROUND

A terminal fitting described in Japanese Patent Laid-Open Publication No. 2012-054107 (Patent Document 1 below) is known as a terminal to be crimped to a wire. This terminal fitting includes a box portion having a rectangular tube shape, a crimping portion in the form of an open barrel disposed behind the box portion and a coupling portion coupling the rear end of the box portion and the front end of the crimping portion. The coupling portion has a pair of side plate portions rising from both side edges of a bottom wall portion and is substantially U-shaped. The front end of a bottom plate portion is connected to the bottom wall portion constituting the box portion, and the rear end of the bottom plate portion is connected to a placing plate portion constituting the crimping portion. The front ends of the side plate portions are connected to side wall portions rising from side edges of the bottom wall portion, and the rear ends of the side plate portions are connected to first crimping pieces rising from side edges of the plating plate portion. In the crimping portion, the first crimping pieces are wound on an end part of the wire placed on the plating plate portion while being curved and deformed, whereby the crimping portion is crimped to the wire. A reinforcing portion continuous from a front end connected to the side wall portion to a rear end connected to the first crimping piece and having a curved region to be wound in is formed on a rising end edge part of the side plate portion.

### PRIOR ART DOCUMENT

### Patent Document

Patent Document 1: JP 2012-054107 A

### SUMMARY OF THE INVENTION

### Problems to be Solved

In the above terminal fitting, the rising end edges of the side plate portions are coupled to the front edges of the first crimping pieces at positions lower than the tops of the first crimping pieces in a crimped state. According to this configuration, the coupling portion is reinforced to a certain extent by the reinforcing portions, but there is a concern for a strength reduction against the bending of the coupling portion if a metal plate as a base material is further thinned according to the miniaturization of the terminal fitting. Further, if the wire becomes thinner according to the miniaturization of the terminal fitting, the crimping portion is reduced in height and the end of the coupling portion remains to be a starting point of bending when being subjected to an external force. Therefore, the strength of the coupling portion needs to be increased more than before to achieve the miniaturization of the terminal fitting and the thinning of the wire.

### Means to Solve the Problem

The present disclosure is directed to a pre-crimped terminal before being crimped to a wire, the pre-crimped terminal being provided with a terminal connecting portion, a wire connecting portion disposed behind the terminal connecting portion, the wire connecting portion being connected to the wire, and a coupling portion coupling the terminal connecting portion and the wire connecting portion, the terminal connecting portion including a first bottom wall and a pair of first side walls rising from both side edges of the first bottom wall, the coupling portion including a second bottom wall connected to the first bottom wall and a pair of second side walls rising from both side edges of the second bottom wall, the wire connecting portion including a third bottom wall connected to the second bottom wall and a pair of third side walls rising from both side edges of the third bottom wall, the wire connecting portion being crimped to the wire by winding the pair of third side walls on an end part of the wire placed on the third bottom wall while curving and deforming the pair of third side walls, and the second side wall being integrally formed to the third side wall in a range reaching a top of the third side wall most distant from the third bottom wall and coupled to the third side wall over an entire height of the second side wall.

### Effect of the Invention

According to the present disclosure, the strength of a coupling portion can be increased and the rear end of the coupling portion can be suppressed from becoming a starting point of bending when being subjected to an external force.

### BRIEF DESCRIPTION OF THE DRAWINGS

FIG. 1 is a perspective view of a pre-crimped terminal when viewed obliquely from behind.

FIG. 2 is a perspective view of the pre-crimped terminal when viewed obliquely from front.

FIG. 3 is a side view of the pre-crimped terminal.

FIG. 4 is a plan view of the pre-crimped terminal.

FIG. 5 is a perspective view of a terminal-equipped wire when viewed obliquely from behind.

FIG. 6 is a perspective view of the terminal-equipped wire when viewed obliquely from front.

FIG. 7 is a side view of the terminal-equipped wire.

FIG. 8 is a plan view of the terminal-equipped wire.

FIG. 9 is a side view enlargedly showing a part of the terminal-equipped wire.

FIG. 10 is a plan view enlargedly showing the part of the terminal-equipped wire.

FIG. 11 is a section along A-A of FIG. 10.

FIG. 12 is a section along B-B of FIG. 10.

FIG. 13 is a section along C-C of FIG. 10.

FIG. 14 is a section along D-D of FIG. 10.

FIG. 15 is a section along E-E of FIG. 10.

FIG. 16 is a section along F-F of FIG. 10.

FIG. 17 is a development of the pre-crimped terminal.

### DETAILED DESCRIPTION TO EXECUTE THE INVENTION

### Description of Embodiments of Present Disclosure

First, embodiments of the present disclosure are listed and described.
(1) The pre-crimped terminal of the present disclosure is a pre-crimped terminal before being crimped to a wire and provided with a terminal connecting portion, a wire connecting portion disposed behind the terminal connecting portion, the wire connecting portion being connected to the wire, and a coupling portion coupling the terminal connecting portion and the wire connecting portion, the terminal connecting portion including a first bottom wall and a pair of first side walls rising from both side edges of the first bottom wall, the coupling portion including a second bottom wall connected to the first bottom wall and a pair of second side walls rising from both side edges of the second bottom wall, the wire connecting portion including a third bottom wall connected to the second bottom wall and a pair of third side walls rising from both side edges of the third bottom wall, the wire connecting portion being crimped to the wire by winding the pair of third side walls on an end part of the wire placed on the third bottom wall while curving and deforming the pair of third side walls, and the second side wall being integrally formed to the third side wall in a range reaching a top of the third side wall most distant from the third bottom wall and coupled to the third side wall over an entire height of the second side wall.

Since the second side wall is integrally formed to the third side wall in the range reaching the top of the third side wall, a recess, which will become a starting point of bending, is not formed in the rear end of the coupling portion and the rear end of the coupling portion can be suppressed from becoming a starting point of bending when being subjected to an external force. Further, since the second side wall is coupled to the third side wall over the entire height, stress is easily transferred from the second side wall to the third side wall, stress applied to the rear end of the coupling portion is easily relieved, and the strength of the coupling portion can be increased.
(2) Preferably, the second side wall is integrally formed to the first side wall in a range not reaching a top of the first side wall most distant from the first bottom wall and coupled to the first side wall over the entire height of the second side wall, and a part coupled to the top of the third side wall, out of the second side wall, is formed to be highest from the second bottom wall.

Since the part coupled to the top of the third side wall, out of the second side wall, is formed to be highest from the second bottom wall, the strength of the vicinity of the rear end of the coupling portion easily becoming a starting point of bending can be increased pin-pointedly.
(3) Preferably, a front end part of the second side wall is formed with a stress relieving portion curved such that a rising end edge from the second bottom wall is smoothly connected to a rear end edge of the first side wall.

Since the front end part of the second side wall is formed with the stress relieving portion, stress is easily transferred from the second side wall to the first side wall, stress applied to the front end of the coupling portion is easily relieved, and the strength of the coupling portion can be increased.
(4) Preferably, the rising end edge of the second side wall from the second bottom wall is provided with the stress relieving portion and a straight portion formed to linearly extend from the stress relieving portion toward the top of the third side wall. Since the straight portion is formed on the rising end edge of the second side wall, the strength of the coupling portion increases toward a rear side and stress is less likely to concentrate on one location.

### Details of Embodiment of Present Disclosure

A specific example of a pre-crimped terminal of the present disclosure is described below with reference to the drawings. Note that the present disclosure is not limited to these illustrations, but is represented by claims and intended to include all changes in the scope of claims and in the meaning and scope of equivalents.

### Pre-Crimped Terminal

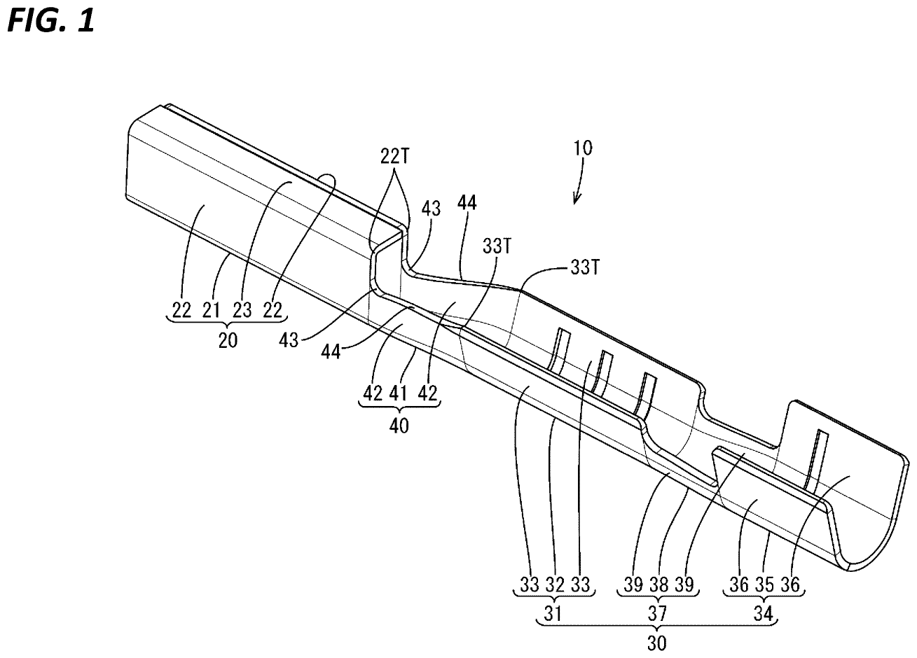

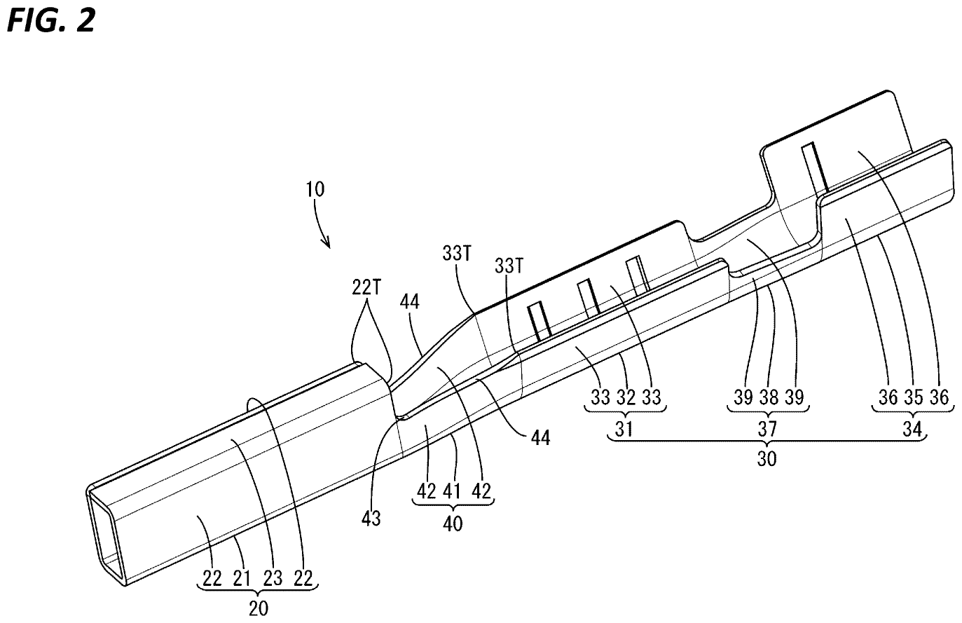

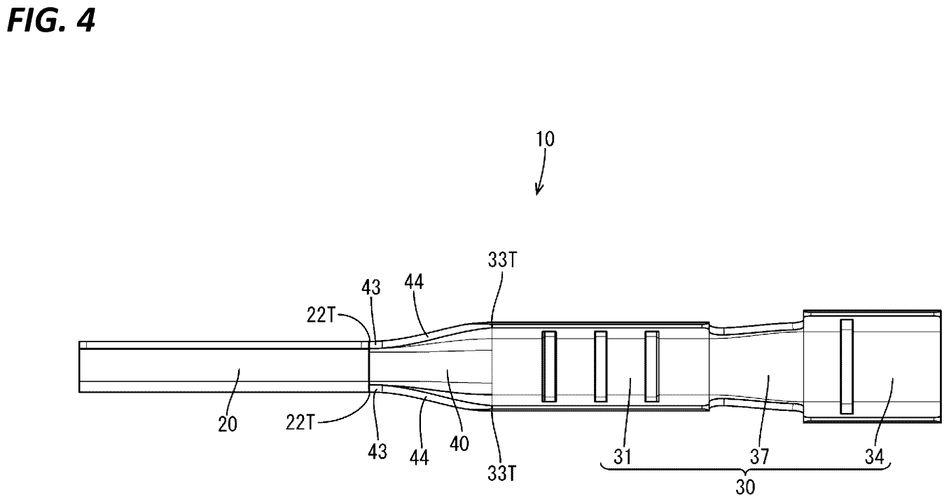

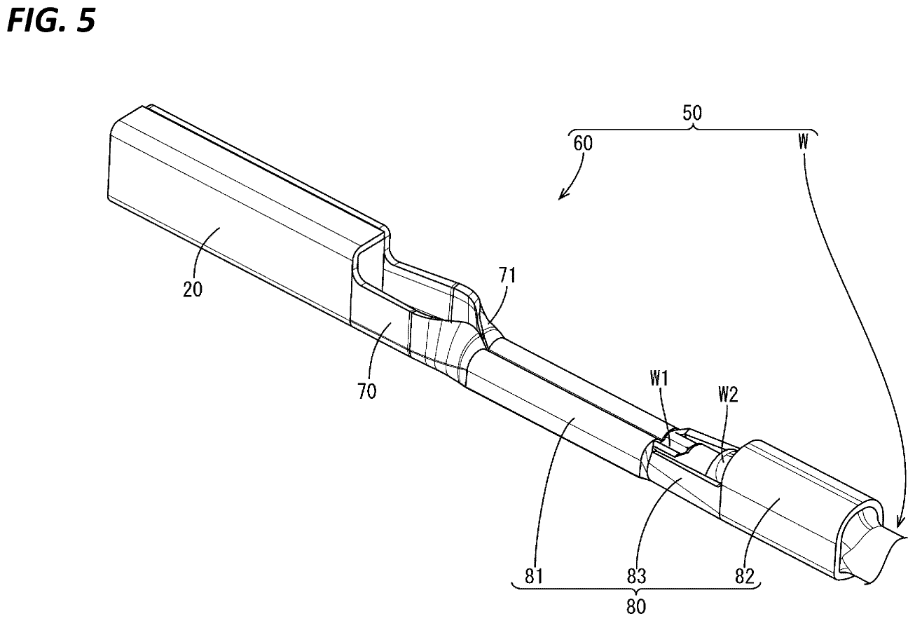

As shown in FIGS. 1 to 4, a pre-crimped terminal 10 is provided with a terminal connecting portion 20 in the form of a rectangular tube, a wire connecting portion 30 in the form of an open barrel disposed behind the terminal connecting portion 20 and a coupling portion 40 coupling the rear end of the terminal connecting portion 20 and the front end of the wire connecting portion 30. The pre-crimped terminal 10 is a female terminal before being crimped to a wire W. An end of the wire W is connected to the wire connecting portion 30. By connecting the pre-crimped terminal 10 to the end of the wire W, a terminal-equipped wire 50 shown in FIG. 5 is configured. The wire W is of a known form surrounding a conductor W1 made of electrically conductive thin wires by an insulation coating W2.

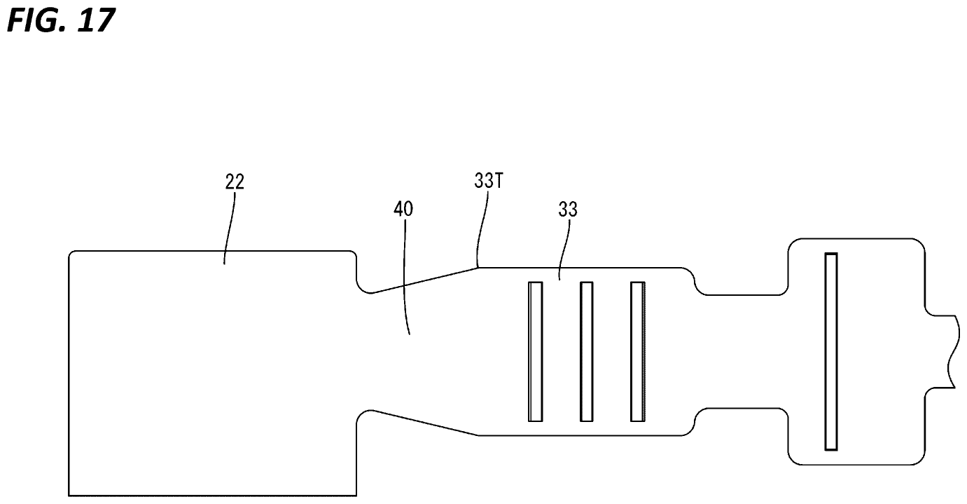

The pre-crimped terminal 10 is formed, such as by being bent after an electrically conductive metal plate material is stamped into a state shown in a development of FIG. 17. Although the inside of the terminal connecting portion 20 is hollow to facilitate graphical representation in this embodiment, a resilient contact piece or the like (not shown) to be conductively connected to a male terminal is formed in the actual pre-crimped terminal. The terminal connecting portion 20 includes a first bottom wall 21, a pair of first side walls 22 rising upward from both side edges of the first bottom wall 21 and a ceiling wall 23 extending from the rising end edge (hereinafter, referred to as an “upper edge”) of one first side wall 22 toward the upper edge of the other first side wall 22.

The wire connecting portion 30 includes a wire barrel 31 to be conductively connected to the conductor W1, an insulation barrel 34 disposed behind the wire barrel 31 and to be fixed to the insulation coating W2 and a linking portion 37 linking the wire barrel 31 and the insulation barrel 34. The wire barrel 31 includes a third bottom wall 32 and a pair of third side walls 33 rising upward from both side edges of the third bottom wall 32. The insulation barrel 32 includes a fourth bottom wall 35 and a pair of fourth side walls 36 rising upward from both side edges of the fourth bottom wall 35. The linking portion 37 includes a fifth bottom wall 38 and a pair of fifth side walls 39 rising upward from both side edges of the fifth bottom wall 38.

The third bottom wall 32 of the wire barrel 31, the fifth bottom wall 38 of the linking portion 37 and the fourth bottom wall 35 of the insulation barrel 34 are integrally formed to be flush with each other. Similarly, the pair of third side walls 33 of the wire barrel 31, the pair of fifth side walls 39 of the linking portion 37 and the pair of fourth side walls 36 of the insulation barrel 34 are integrally formed to be flush with each other.

The wire barrel 31 is longer than the insulation barrel 34 and the linking portion 37 in a front-rear direction. Further, the pair of third side walls 33 of the wire barrel 31 are shorter than the pair of fourth side walls 36 of the insulation barrel 34 in a vertical direction and longer than the pair of fifth side walls 39 of the linking portion 37 in the vertical direction.

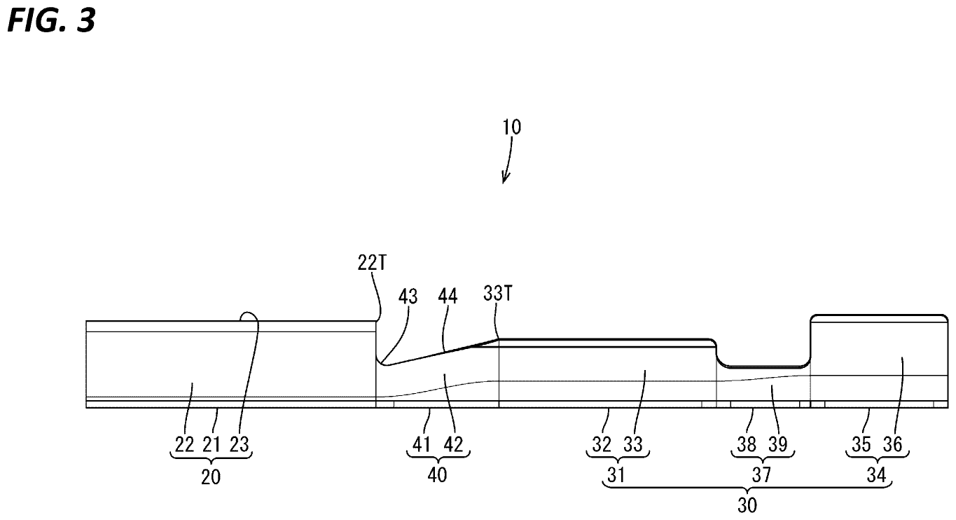

The coupling portion 40 includes a second bottom wall 41 and a pair of second side walls 42 rising upward from both side edges of the second bottom wall 41. The front end of the second bottom wall 41 is coupled to the rear end of the first bottom wall 21 of the terminal connecting portion 20, and the rear end of the second bottom wall 41 is coupled to the front end of the third bottom wall 32 of the wire barrel 31. As shown in FIG. 3, the first bottom wall 21 of the terminal connecting portion 20, the second bottom wall 41 of the coupling portion 40 and the third bottom wall 32 of the wire barrel 31 are integrally formed to be flush with each other.

The second side wall 42 is integrally formed to the third side wall 33 in a range reaching a top 33T of the third side wall 33 of the wire barrel 31 most distant from the third bottom wall 32. Accordingly, the second side wall 42 is coupled to the third side wall 33 over the entire height of the second side wall 42.

The second side wall 42 is integrally formed to the first side wall 22 in a range not reaching a top 22T of the first side wall 22 of the terminal connecting portion 20 most distant from the first bottom wall 21. The second side wall 42 is coupled to the first side wall 22 over the entire height of the second side wall 42. A part coupled to the top 33T of the third side wall 33, out of the second side wall 42, is formed to be highest from the second bottom wall 41.

Out of the second side wall 42, a rising end edge from the second bottom wall 41 is provided with a stress relieving portion 43 and a straight portion 44. The stress relieving portion 43 is formed in a front end part of the second side wall 42, and the rising end edge from the second bottom wall 41 is curved to be smoothly connected to the rear end edge of the first side wall 22. The straight portion 44 is formed to linearly extend from the stress relieving portion 43 toward the part coupled to the top 33T of the third side wall 33. Note that a retaining member is locked to the rear ends of the first side walls 22 (parts extending upward from the stress relieving portion 43) and the rear end of the ceiling wall 23 when the terminal-equipped wire 50 is accommodated into a housing, whereby the terminal-equipped wire 50 is retained.

### Terminal-Equipped Wire

The terminal-equipped wire 50 is provided with a terminal 60 and the wire W. The terminal 60 is a post-crimped terminal formed by crimping the wire connecting portion 30 of the pre-crimped terminal 10 to the wire W. Out of components of the terminal 60, those common to the pre-crimped terminal 10 are denoted by the same reference signs and not described.

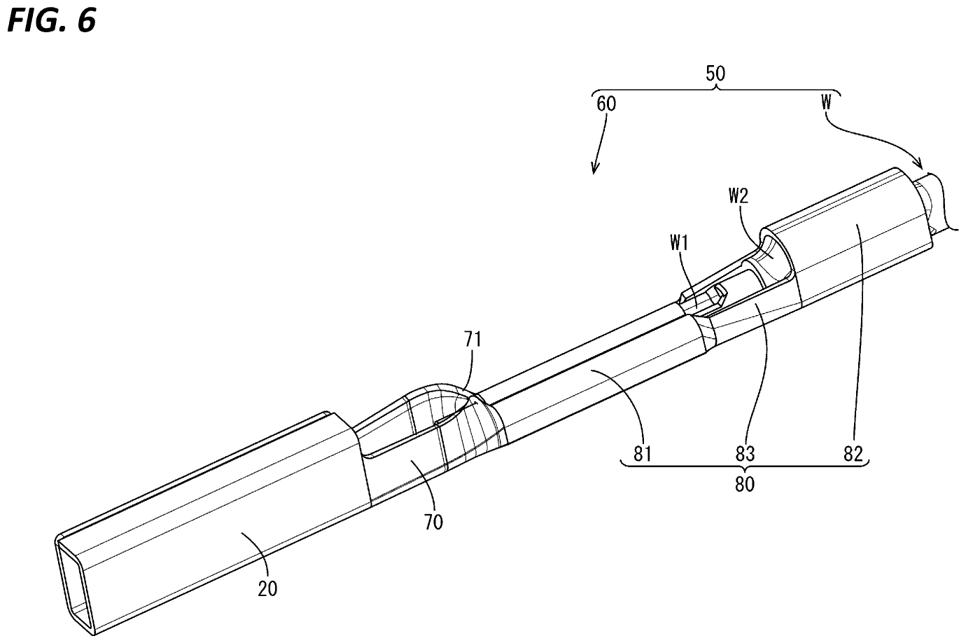

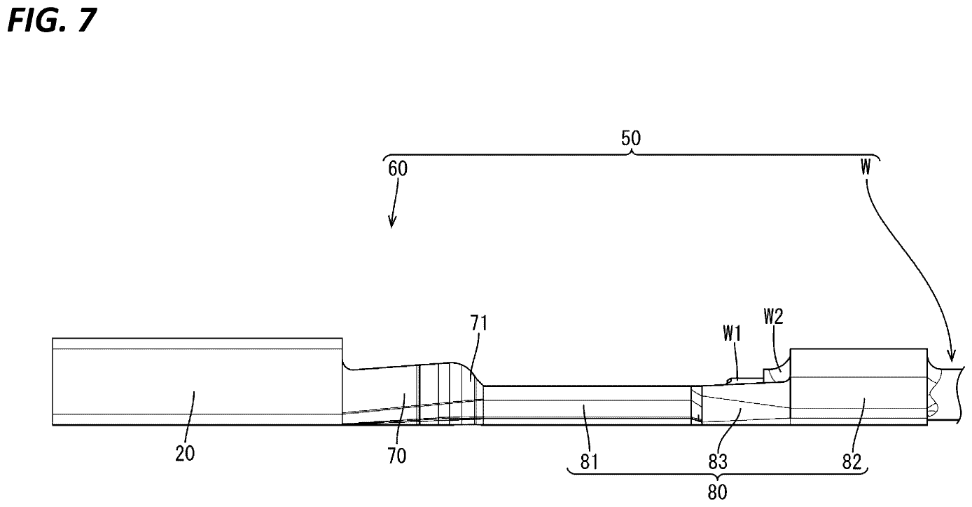

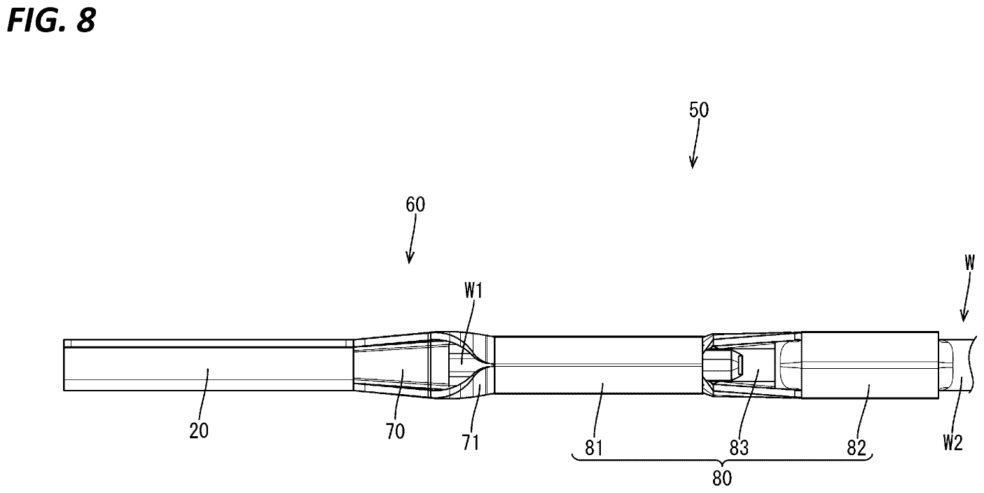

As shown in FIGS. 5 to 8, the terminal 60 is provided with a terminal connecting portion 20, a coupling portion 70 and a wire connecting portion 80. The wire connecting portion 80 includes a wire barrel 81 crimped to the conductor W1, an insulation barrel 82 crimped to the insulation barrel W2 and a linking portion 83 linking the wire barrel 81 and the insulation barrel 82.

Before crimping to the wire W, the insulation coating W2 is removed over a region slightly longer than a length in the front-rear direction of the wire barrel 81 in a front end part of the wire W, whereby the conductor W1 is exposed (stripped). At the time of crimping to the wire W, an exposed part of the conductor W1 is placed on the third bottom wall 32 and, subsequently, the pair of third side walls 33 are fixed while being curved and deformed to wind (surround) on the conductor W1. That is, in the wire barrel 81 of the wire connecting portion 80, the pair of third side walls 33 are wound on the conductor W1 placed on the third bottom wall 32 while being curved and deformed. In this way, the wire barrel 81 is crimped to the wire W.

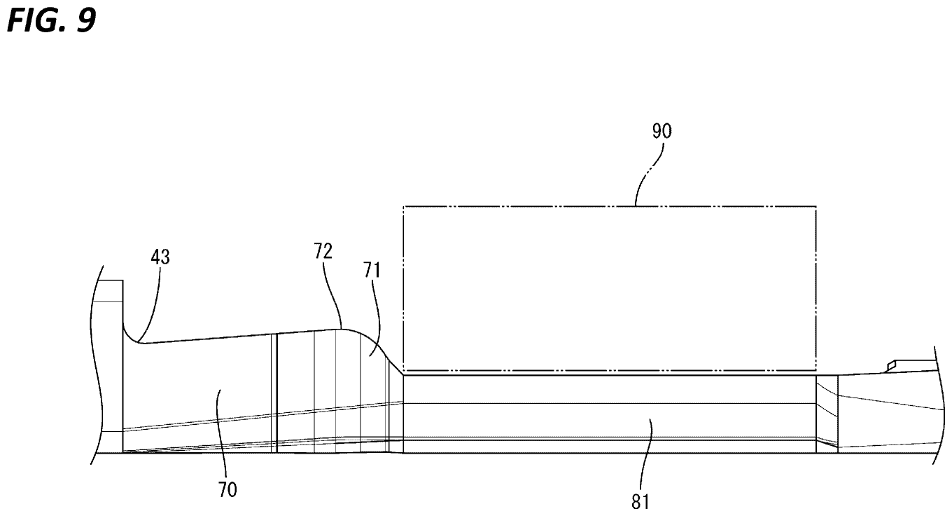

As shown in FIG. 9, the wire barrel 81 is crimped using a mold 90 having the same length in the front-rear direction as the wire barrel 81. Normally, tapered inclined surfaces are formed before and after such a mold, and bell mouths are formed on both front and rear ends of the wire barrel 81 by those inclined surfaces. However, although the mold 90 are not formed with inclined surfaces, a bell mouth 71 is formed on the front end of the wire barrel 81 in the terminal 60 of the present disclosure.

This bell mouth 71 is formed in the coupling portion 70. The bell mouth 71 is shaped to extend upward toward the front from the front end of the wire barrel 81. A range from a top 72 of the bell mouth 71 toward the stress relieving portion 43 is linearly formed to be gently inclined obliquely downward. A rear end side of the coupling portion 70 is drastically thickened by the bell mouth 71, and the strength of the coupling portion 70 is increased by 1.4 to 1.8 folds as compared to the case where the bell mouth 71 is not provided. Further, stress applied to the coupling portion 70 is distributed by the bell mouth 71 and the rear end of the coupling portion 70 can be suppressed from becoming a starting point of bending.

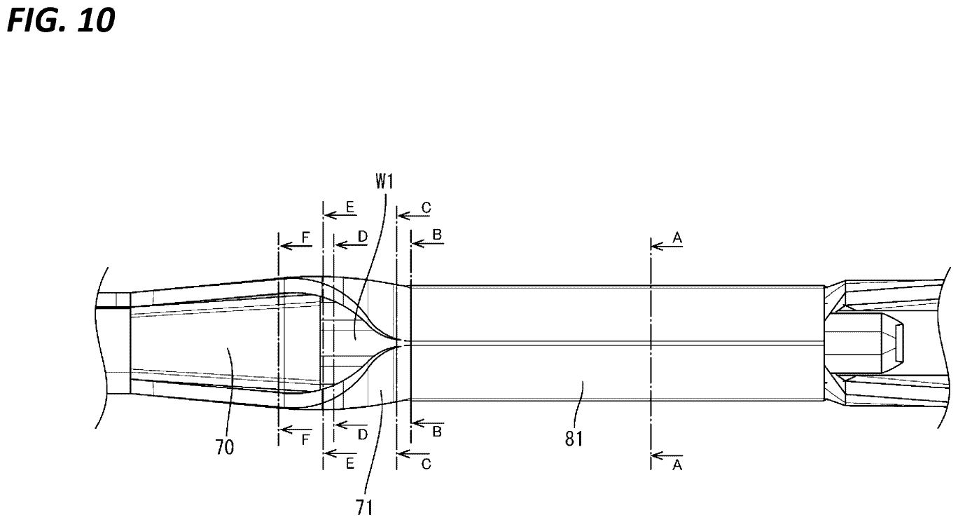

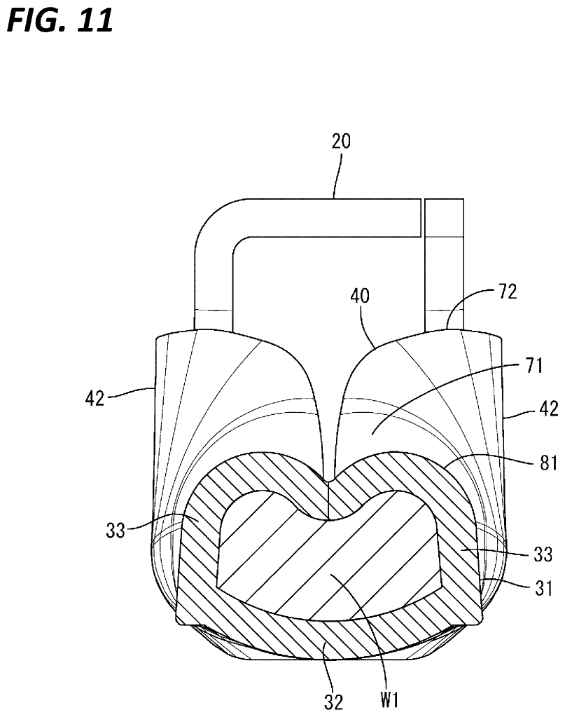

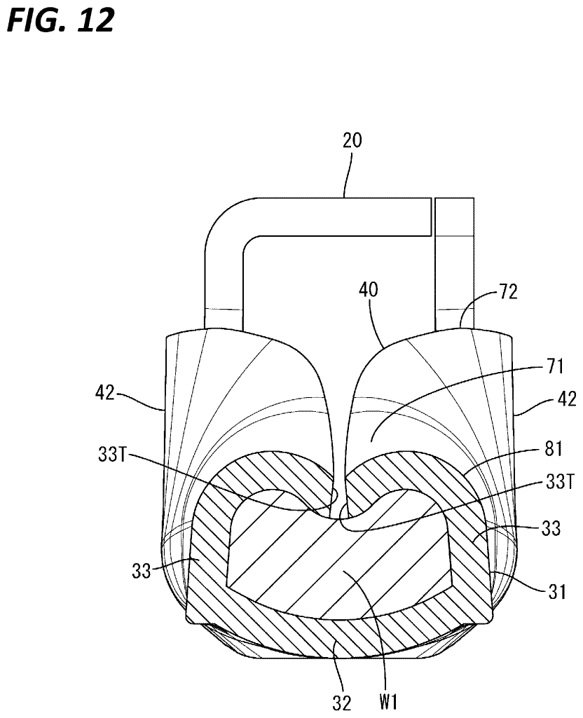

FIG. 11 is a section along A-A of FIG. 10 of a center in the front-rear direction of the wire barrel 81. The pair of third side walls 33 are crimped to the conductor W1 by the mold 90. A state is shown where the tips of the pair of third side walls 33 are butted against each other and pushed in toward the third bottom wall 32. FIG. 12 is a section along B-B of FIG. 10 of the front end of the wire barrel 81. Although the pair of third side walls 33 are crimped to the conductor W1, the tips of the pair of third side walls 33 are slightly separated. Out of the pair of second side walls 42 shown in FIG. 12, parts reaching the top 72 constitute the bell mouth 71.

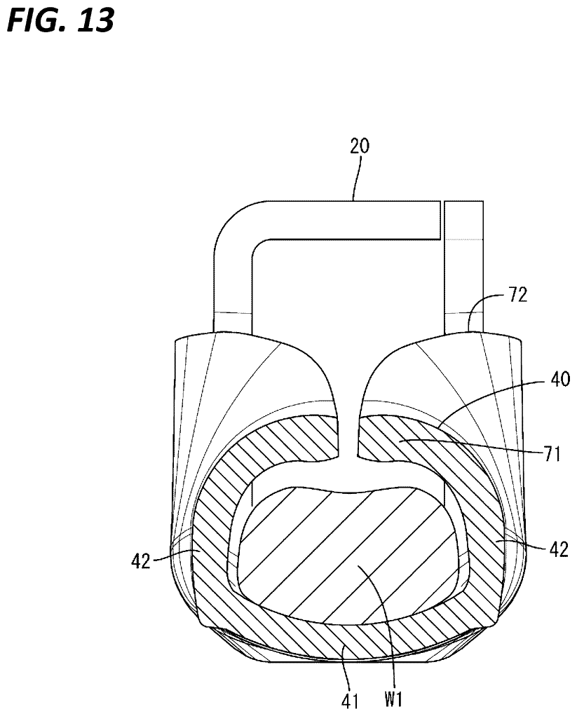

FIG. 13 is a section along C-C of FIG. 10 of the coupling portion 40. Although the pair of second side walls 42 are separated from the conductor W1, the tips of the pair of second side walls 42 are parallel to the second bottom wall 41 and arranged to face each other while being slightly separated.

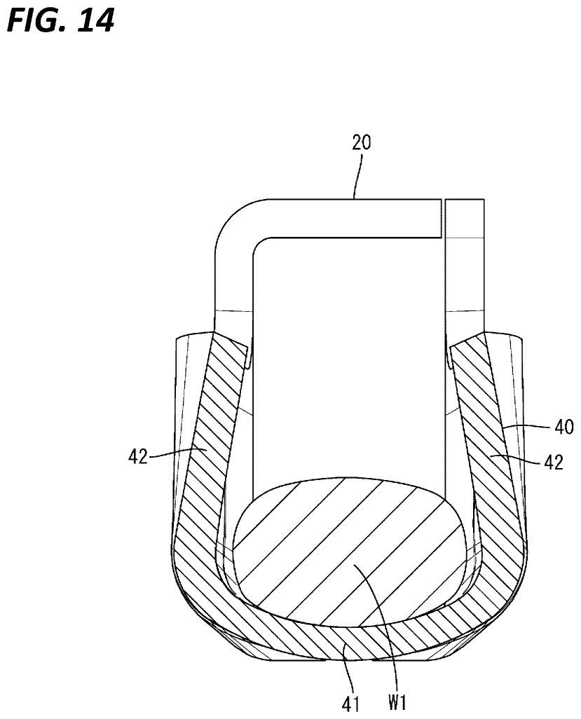

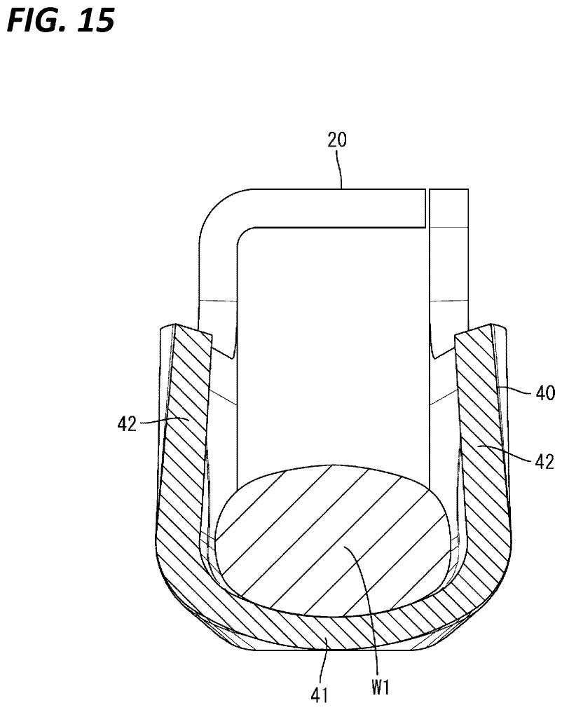

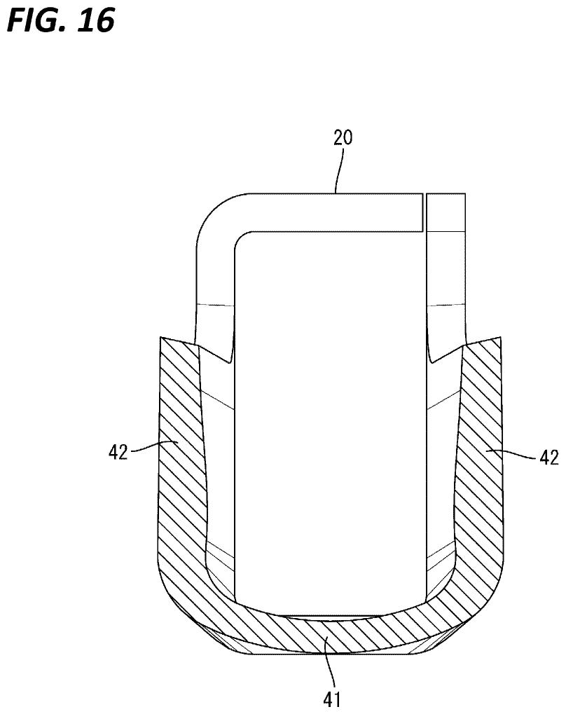

FIG. 14 is a section along D-D of FIG. 10 of a part of the coupling portion 40 slightly in front of a part shown in FIG. 13. The pair of second side walls 42 substantially linearly rise, and the tips of the pair of second side walls 42 are facing obliquely upward. FIG. 15 is a section along E-E of FIG. 10 of a part of the coupling portion 40 slightly in front of the part shown in FIG. 14. The pair of second side walls 42 are shown to rise substantially at an angle closer to a perpendicular angle than in FIG. 14. FIG. 16 is a section along F-F of FIG. 10 of a part of the coupling portion 40 slightly in front of the part shown in FIG. 15. The pair of second side walls 42 rise perpendicularly and have almost the same shape as those before crimping.

FIG. 17 is a development of the pre-crimped terminal 10. A state is shown where both side edges of the coupling portion 40 are linearly formed from the tops 33T of the pair of third side walls 33 toward the first side walls 22, these parts correspond to the straight portions 44 and the coupling portion 44 is thickened and reinforced.

### Functions and Effects of Pre-Crimped Terminal of Present Disclosure

The pre-crimped terminal 10 of the present disclosure is the pre-crimped terminal 10 before being crimped to the wire W and provided with the terminal connecting portion 20, the wire connecting portion 30 disposed behind the terminal connecting portion 20 and to be connected to the wire W and the coupling portion 40 coupling the terminal connecting portion 20 and the wire connecting portion 30. The terminal connecting portion 20 includes the first bottom wall 21 and the pair of first side walls 22 rising form the both side edges of the first bottom wall 21. The coupling portion 40 includes the second bottom wall 41 connected to the first bottom wall 21 and the pair of second side walls 42 rising form the both side edges of the second bottom wall 41. The wire barrel 31 of the wire connecting portion 30 includes the third bottom wall 32 connected to the second bottom wall 41 and the pair of third side walls 33 rising form the both side edges of the third bottom wall 32. The wire connecting portion 30 is crimped to the wire W by winding the pair of third side walls 33 on the end part of the wire W placed on the third bottom wall 32 while curving and deforming the pair of third side walls 33. The second side wall 42 is integrally formed to the third side wall 33 in the range reaching the top 33T of the third side wall 33 most distant from the third bottom wall 32, and coupled to the third side wall 33 over the entire height of the second side wall 42.

Since the second side wall 42 is integrally formed to the third side wall 33 in the range reaching the top 33T of the third side wall 33, a recess, which will become a starting point of bending, is not formed in the rear end of the coupling portion 40 and the rear end of the coupling portion 40 can be suppressed from becoming a starting point of bending when being subjected to an external force. Further, since the second side wall 42 is coupled to the third side wall 33 over the entire height, stress is easily transferred from the second side wall 42 to the third side wall 33, stress applied to the rear end of the coupling portion 40 is easily relieved and the strength of the coupling portion 40 can be increased.

Preferably, the second side wall 42 is integrally formed to the first side wall 22 in the range not reaching the top 22T of the first side wall 22 most distant from the first bottom wall 21 and coupled to the first side wall 22 over the entire height of the second side wall 42, and the part coupled to the top 33T of the third side wall 33, out of the second side wall 42, is formed to be highest from the second bottom wall 41.

Since the part coupled to the top 33T of the third side wall 33, out of the second side wall 42, is formed to be highest from the second bottom wall 41, the strength of the vicinity of the rear end of the coupling portion 40 easily becoming a starting point of bending can be increased pin-pointedly.

Preferably, the front end part of the second side wall 42 is formed with the stress relieving portion 43 curved such that the rising end edge from the second bottom wall 41 is smoothly connected to the rear end edge of the first side wall 22.

Since the front end part of the second side wall 42 is formed with the stress relieving portion 43, stress is easily transferred from the second side wall 42 to the first side wall 22, stress applied to the front end of the coupling portion 40 is easily relieved and the strength of the coupling portion 40 can be increased.

Preferably, the rising end edge of the second side wall 42 from the second bottom wall 41 is provided with the stress relieving portion 43 and the straight portion 44 formed to linearly extend from the stress relieving portion 43 toward the top 33T of the third side wall 33.

Since the rising end edge of the second side wall 42 is formed with the straight portion 44, the strength of the coupling portion 40 increases toward a rear side and stress is less likely to concentrate on one location.

### Other Embodiments

(1) Although the wire connecting portion 30 is illustrated to include the wire barrel 31 and the insulation barrel 34 in the above embodiment, a wire connecting portion may include only a wire barrel.
(2) Although the linking portion 37 is connected in the range not reaching the tops of the fourth side walls 36 of the insulation barrel 34 in the above embodiment, a linking portion may be connected in a range reaching the tops of the fourth side walls 36 of the insulation barrel 34. By doing so, the strength of the fourth side walls 36 of the linking portion 37 can be increased.
(3) Although the part coupled to the top 33T of the third side wall 33, out of the second side wall 42 of the coupling portion 40, is formed to be highest from the second bottom wall 41 in the above embodiment, a second side wall may be highest at a middle position of a straight portion. Further, the part extending from the stress relieving portion 43 toward the top 33T of the third side wall 33 may not be straight, but may be arcuate.
(4) Although the stress relieving portion 43 is formed to be curved in the above embodiment, a stress relieving portion may be linearly formed at an obtuse angle to the rear end edge of the first side wall 22.

### LIST OF REFERENCE NUMERALS

10: pre-crimped terminal
20: terminal connecting portion, 21: first bottom wall, 22: first side wall, 22T: top, 23: ceiling wall
30: wire connecting portion, 31: wire barrel, 32: third bottom wall, 33: third side wall, 33T: top, 34: insulation barrel, 35: fourth bottom wall, 36: fourth side wall, 37: linking portion, 38: fifth bottom wall, 39: fifth side wall
40: coupling portion, 41: second bottom wall, 42: second side wall, 43: stress relieving portion, 44: straight portion
50: terminal-equipped wire
60: terminal
70: coupling portion, 71: bell mouth, 72: top
80: wire connecting portion, 81: wire barrel, 82: insulation barrel, 83: linking portion
90: mold
W: wire, W1: conductor, W2: insulation coating

1. A pre-crimped terminal before being crimped to a wire, comprising:
a terminal connecting portion;
a wire connecting portion disposed behind the terminal connecting portion, the wire connecting portion being connected to the wire; and
a coupling portion coupling the terminal connecting portion and the wire connecting portion,
the terminal connecting portion including a first bottom wall and a pair of first side walls rising from both side edges of the first bottom wall,
the coupling portion including a second bottom wall connected to the first bottom wall and a pair of second side walls rising from both side edges of the second bottom wall,
the wire connecting portion including a third bottom wall connected to the second bottom wall and a pair of third side walls rising from both side edges of the third bottom wall,
the wire connecting portion being crimped to the wire by winding the pair of third side walls on an end part of the wire placed on the third bottom wall while curving and deforming the pair of third side walls, and
the second side wall being integrally formed to the third side wall in a range reaching a top of the third side wall most distant from the third bottom wall and coupled to the third side wall over an entire height of the second side wall.

2. The pre-crimped terminal of claim 1, wherein:
the second side wall is integrally formed to the first side wall in a range not reaching a top of the first side wall most distant from the first bottom wall and coupled to the first side wall over the entire height of the second side wall, and
a part coupled to the top of the third side wall, out of the second side wall, is formed to be highest from the second bottom wall.

3. The pre-crimped terminal of claim 1, wherein a front end part of the second side wall is formed with a stress relieving portion curved such that a rising end edge from the second bottom wall is smoothly connected to a rear end edge of the first side wall.

4. The pre-crimped terminal of claim 3, wherein the rising end edge of the second side wall from the second bottom wall is provided with the stress relieving portion and a straight portion formed to linearly extend from the stress relieving portion toward the top of the third side wall.
